(19) United States
(12) Patent Application Publication
(10) Pub. No.: US 2023/0230604 A1
(43) Pub. Date: Jul. 20, 2023

(54) METHOD OF ENCODING AUDIO SIGNAL AND ENCODER, METHOD OF DECODING AUDIO SIGNAL AND DECODER

(71) Applicants: Electronics and Telecommunications Research Institute, Daejeon (KR); Gwangju Institute of Science and Technology, Gwangju (KR)

(72) Inventors: Inseon JANG, Daejeon (KR); Tae Jin LEE, Daejeon (KR); Seung Kwon BEACK, Daejeon (KR); Jongmo SUNG, Daejeon (KR); Woo-taek LIM, Daejeon (KR); Byeongho CHO, Daejeon (KR); Jongwon SHIN, Gwangju (KR); Soojoong HWANG, Gwangju (KR); Eunkyun LEE, Gwangju (KR); Youngwon CHOI, Gwangju (KR); Sangwook HAN, Gwangju (KR)

(73) Assignees: Electronics and Telecommunications Research Institute, Daejeon (KR); Gwangju Institute of Science and Technology, Gwangju (KR)

(21) Appl. No.: 18/099,119

(22) Filed: Jan. 19, 2023

(30) Foreign Application Priority Data
Jan. 20, 2022 (KR) 10-2022-0008366
Jan. 10, 2023 (KR) 10-2023-0003733

(51) Int. Cl. G10L 19/02; G10L 25/30

(52) U.S. Cl. CPC G10L 19/0204; G10L 25/30

(57) ABSTRACT

A method of encoding an audio signal and an encoder and a method of decoding an audio signal and a decoder are provided. The method of encoding an audio signal includes outputting a decoded signal by using a bitstream that encodes an audio signal, separating the decoded signal into a low-band signal and a high-band signal by using a sound source separator, upsampling the low-band signal, upsampling the high-band signal, and restoring the audio signal by synthesizing the upsampled low-band signal with the upsampled high-band signal, wherein the bitstream is generated by encoding a superimposed signal in which a signal in a high frequency band of the audio signal is superimposed on a low frequency band of the audio signal.

### CROSS-REFERENCE TO RELATED APPLICATION

This application claims the benefit of Korean Patent Application No. 10-2022-0008366 filed on Jan. 20, 2022, and Korean Patent Application No. 10-2023-0003733 filed on Jan. 10, 2023, in the Korean Intellectual Property Office, the entire disclosure of which is incorporated herein by reference for all purposes.

### BACKGROUND

### 1. Field of the Invention

One or more example embodiments relate to a method of encoding an audio signal and an encoder and a method of decoding an audio signal and a decoder.

### 2. Description of the Related Art

A sampling rate of an input signal for operating an audio codec may be fixed and the audio codec may not encode a component of frequency bands other than a frequency band determined in the design, based on the fixed sampling rate.

To improve the sound quality of an audio signal by encoding a signal in a wide frequency band, a new codec may need to be designed and replace the existing codec to improve the sampling rate.

To maintain backward compatibility, a downsampling technique using a low-pass filter to improve the sound quality of the audio signal without replacing the existing audio codec and a bandwidth extension technique after encoding and/or decoding may be used.

### SUMMARY

Example embodiments provide a method of encoding an audio signal and an encoder, a method of decoding an audio signal and a decoder for maintaining backward compatibility by encoding an input audio signal preserving a high-pitched component, improving the sound quality of the audio signal by decoding an encoded bitstream preserving the high-pitched component, and using an encoder in a sampling rate that is lower than a sampling rate of a restored audio signal.

Example embodiments provide an encoder, a decoder, and a method of efficiently encoding and decoding an audio signal of a high sampling rate using an audio codec with a low sampling rate.

According to an aspect, there is provided a method of encoding an audio signal including outputting a decoded signal by using a bitstream that encodes an audio signal, separating the decoded signal into a low-band signal and a high-band signal by using a sound source separator, upsampling the low-band signal, upsampling the high-band signal, and restoring the audio signal by synthesizing the upsampled low-band signal with the upsampled high-band signal, wherein the bitstream is generated by encoding a superimposed signal in which a signal in a high frequency band of the audio signal is superimposed on a low frequency band of the audio signal.

The sound source separator includes a neural network trained to separate the decoded signal into the low-band signal and the high-band signal.

The neural network is trained to minimize a scale-invariant signal-to-noise ratio (SI-SNR) determined based on the audio signal and a restored audio signal.

The upsampling of the low-band signal includes zero-padding the low-band signal, and processing the low-band signal by a low-pass filter corresponding to the low-band signal, and wherein the upsampling of the high-band signal includes zero-padding the high-band signal, and processing the high-band signal by a high-pass filter corresponding to the high-band signal.

The restoring of the audio signal includes restoring the audio signal at a sampling rate that is higher than a sampling rate of the decoded signal.

According to an aspect, there is provided a method of encoding an audio signal including downsampling an audio signal by a superimposed signal in which a signal in a high frequency band of the audio signal is superimposed on a low frequency band of the audio signal, and outputting a bitstream by encoding the superimposed signal.

The downsampling of the audio signal includes superimposing the signal of the high frequency band of the audio signal on the signal of the low frequency band as an aliasing signal.

According to an aspect, there is provided a decoder including a processor, wherein the processor is configured to output a decoded signal using a bitstream in which an audio signal is encoded, separate the decoded signal into a low-band signal and a high-band signal by using a sound source separator, upsample the low-band signal, upsample the high-band signal, and restore the audio signal by synthesizing the upsampled low-band signal with the upsampled high-band signal, wherein the bitstream is generated by encoding a superimposed signal in which a signal in a high frequency band of the audio signal is superimposed on a low frequency band of the audio signal.

The sound source separator includes a neural network trained to separate the decoded signal into the low-band signal and the high-band signal.

The neural network is trained to minimize an SI-SNR determined based on the audio signal and a restored audio signal.

The processor is further configured to zero-pad the low-band signal, process the low-band signal by a low-pass filter corresponding to the low-band signal, zero-pad the high-band signal, and process the high-band signal by a high-pass filter corresponding to the high-band signal.

The processor is further configured to restore the audio signal at a sampling rate that is higher than a sampling rate of the decoded signal.

Additional aspects of example embodiments will be set forth in part in the description which follows and, in part, will be apparent from the description, or may be learned by practice of the disclosure.

According to an example embodiment, a high-quality audio signal may be provided to a user by efficiently encoding and decoding a signal of a high sampling rate without replacing a codec with a low sampling rate.

According to an example embodiment, backward compatibility for the existing audio codec may be maintained and an audio signal with similar or improved sound quality may be provided compared to an audio signal encoded at the same level of bit rate by a codec with a high sampling rate.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a schematic block diagram of an encoder according to various example embodiments;

FIG. 2 is a diagram illustrating an operation of an encoder, according to various example embodiments;

FIG. 3 is a schematic block diagram of a decoder according to various example embodiments;

FIG. 4 is a diagram illustrating an operation of a decoder according to various example embodiment;

FIG. 5 is a flowchart illustrating an operation of an audio signal encoding method, according to various example embodiments;

FIG. 6 is a diagram illustrating a superimposed signal according to various example embodiments;

FIG. 7 is a flowchart of an operation of an audio signal decoding method according to various example embodiments;

FIG. 8 is a diagram illustrating an upsampling operation according to various example embodiments;

FIG. 9 is a diagram illustrating a spectrogram of an audio signal according to various example embodiments; and

FIG. 10A and FIG. 10B are diagrams illustrating a result of listening evaluation of an audio signal according to various example embodiments.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

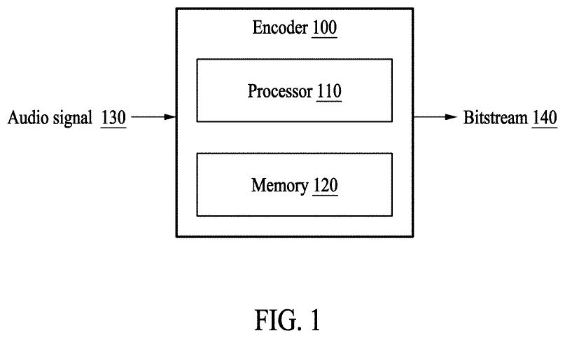

FIG. 1 is a schematic block diagram of an encoder 100 according to various example embodiments.

Referring to FIG. 1, the encoder 100 may include a processor 110 and a memory 120.

The processor 110 may execute, for example, software (e.g., a program) to control at least one other component (e.g., a hardware or software component) of an electronic device connected to the processor 110 and may perform various data processing or computations. According to an example embodiment, as at least a part of data processing or computations, the processor 110 may store a command or data received from another component (e.g., a sensor module or a communication module) in a volatile memory, process the command or the data stored in the volatile memory, and store resulting data in a non-volatile memory. According to one embodiment, the processor 110 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently from or in conjunction with the main processor. For example, when the electronic device includes the main processor and the auxiliary processor, the auxiliary processor may be adapted to consume less power than the main processor or to be specific to a specified function. The auxiliary processor may be implemented separately from the main processor or as a part of the main processor.

The auxiliary processor may control at least some of functions or states related to at least one (e.g., a display module, a sensor module, or a communication module) of the components of an electronic device, instead of the main processor while the main processor is in an inactive (e.g., sleep) state or along with the main processor while the main processor is an active state (e.g., executing an application). According to one embodiment, the auxiliary processor (e.g., an ISP or a CP) may be implemented as a portion of another component (e.g., a camera module or a communication module) that is functionally related to the auxiliary processor. According to one embodiment, the auxiliary processor (e.g., an NPU) may include a hardware structure specified for artificial intelligence (AI) model processing. An AI model may be generated by machine learning. Such learning may be performed by, for example, an electronic device in which AI is performed, or performed via a separate server (e.g., a server #08). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 120 may store various pieces of data used by at least one component (e.g., the processor 110 or a sensor module) of an electronic device. The various pieces of data may include, for example, software (e.g., a program) and input data or output data for a command related thereto. The memory 120 may include a volatile memory or a non-volatile memory. For example, the encoder 100 may output a bitstream 140 obtained by encoding an audio signal 130. For example, the encoder 100 may output the bitstream 140 obtained by encoding the audio signal 130 based on a set sampling rate.

The encoder 100 may generate a superimposed signal by using the audio signal 130. For example, the encoder 100 may generate a superimposed signal at a sampling rate that is lower than a sampling rate of the audio signal 130 by downsampling the audio signal 130.

For example, the encoder 100 may generate a superimposed signal in which a signal in a high frequency band of the audio signal 130 is superimposed on a low frequency band of the audio signal 130. For example, the encoder 100 may generate a superimposed signal by using sub-Nyquist sampling. The sub-Nyquist sampling may represent a sampling method that decimates the audio signal 130 and superimposes a high frequency component of the audio signal 130 on a low frequency band of the audio signal 130.

For example, the encoder 100 may superimpose a signal or a component in a high frequency band of the audio signal 130 on a low frequency band of audio signal 130 as an aliasing signal.

The encoder 100 may encode the superimposed signal and may output the bitstream 140. For example, the set sampling rate of the encoder 100 may be lower than the sampling rate of the audio signal 130.

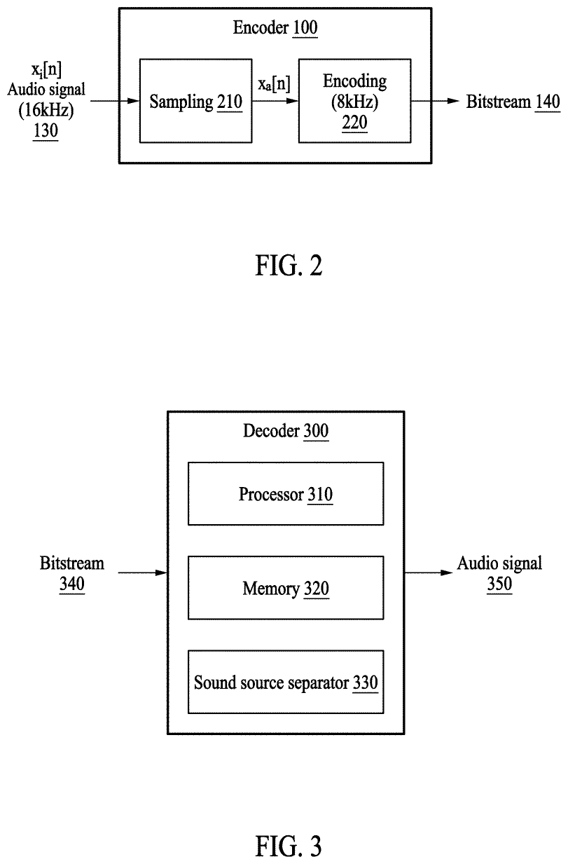

FIG. 2 is a diagram illustrating an operation of the encoder 100, according to various example embodiments.

Referring to FIG. 2, in operation 210, the encoder 100 may sample the audio signal 130. For example, the encoder 100 may generate a superimposed signal xₐ [n] by sampling the audio signal 130 xᵢ[n].

For example, the encoder 100 may generate the superimposed signal xₐ[n] by superimposing a signal or a component in a high frequency band of the audio signal 130 on a signal of a low frequency band as an aliasing signal. For example, the sampling rate of the superimposed signal may be lower than the sampling rate of the audio signal 130.

FIG. 2 is one of various example embodiments and is a diagram illustrating operations of the encoder 100 to generate a superimposed signal at 8 kHz by sampling the audio signal 130 at a sampling rate of 16 kHz. The sampling rate of the audio signal 130 and the sampling rate of the superimposed signal are not limited to the examples illustrated in FIG. 2 and may be variously set.

In operation 220, the encoder 100 may output the bitstream 140 by encoding the superimposed signal xₐ [n] based on a preset sampling rate. For example, the encoder 100 may output the bitstream 140 by encoding the superimposed signal xₐ [n] based on a preset sampling rate of 8 kHz.

FIG. 3 is a schematic block diagram of a decoder 300 according to various example embodiments.

Referring to FIG. 3, the decoder 300 may include at least one or any combination of a processor 310, a memory 320, and a sound source separator 330. The descriptions of the processor 110 and the memory 120 provided with reference to FIGS. 1 and 2 may be applicable to the processor 310 and the memory 320 of FIG. 3 in substantially the same manner. The decoder 300 may perform operations of the decoder 300 or may control a component (e.g., the sound source separator 330) of the decoder 300 to perform an operation by using the processor 310 and/or the memory 320. The decoder 300 may output a decoded signal by using a bitstream 340 that encodes an audio signal 130. For example, the bitstream 340 that encodes the audio signal 130 may be the bitstream 340 output by the encoder 100 of FIGS. 1 and 2.

For example, the bitstream 340 may be generated by encoding a superimposed signal in which a signal in a high frequency band of the audio signal 130 is superimposed on a low frequency band of the audio signal 130.

The decoder 300 may separate a decoded signal into a low-band signal and a high-band signal by using the sound source separator 330. The decoder 300 may upsample the low-band signal and the high-band signal.

For example, the decoder 300 may process a low-band signal to upsample the low-band signal by using zero-padding and a low-pass filter (LPF).

For example, the decoder 300 may zero-pad the low-band signal. The decoder 300 may process a zero-padded low-band signal by the LPF. A cutoff frequency of the LPF may be determined based on a frequency band of a low-band signal.

For example, the decoder 300 may process a high-band signal by using zero-padding and a high-pass filter (HPF) to upsample the high-band signal.

For example, the decoder 300 may zero-pad a high-band signal. The decoder 300 may process a zero-padded high-band signal by the HPF. A cutoff frequency of the HPF may be determined based on a frequency band of a high-band signal.

The decoder 300 may restore the audio signal 350 by synthesizing the upsampled low-band signal with the upsampled high-band signal.

For example, the sound source separator 330 may include a neural network that is trained to separate a decoded signal into a low-band signal and a high-band signal. For example, the sound source separator 330 may separate a decoded signal into a low-band signal and a high-band signal by using the trained neural network.

For example, the neural network may be trained to minimize a determined scale-invariant signal-to-noise ratio (SI-SNR), based on the audio signal 130 and the restored audio signal 350. The neural network may be trained by using a loss function [symbol] determined based on the SI-SNR as defined in Equations 1 and 2 shown below. The neural network may be trained to minimize the loss function [symbol] .

$$\begin{matrix}SI - SNR ( a [ n ] , b [ n ] ) = 10 {log}_{10} \frac{{{ρ}_{n} ( α \cdot b [ n ] )}^{2}}{{{Σ}_{n} ( a [ n ] - α \cdot b [ n ] )}^{2}} & [ Equation 1 ] \\ α = \frac{{Σ}_{n} a [ n ] \cdot b [ n ]}{{Σ}_{n} {b [ n ]}^{2}} & [ Equation 2 ]\end{matrix}$$

In Equation 1, α may be defined as Equation 2. In Equations 1 and 2, a[n] may denote the original audio signal 130 that is input to the encoder 100 and b[n] may denote the decoded or reconstructed audio signal 350 output by the decoder 300.

The sampling rate of the audio signal 350 output by the decoder 300 may be greater than the sampling rate of a signal obtained by decoding the bitstream 340.

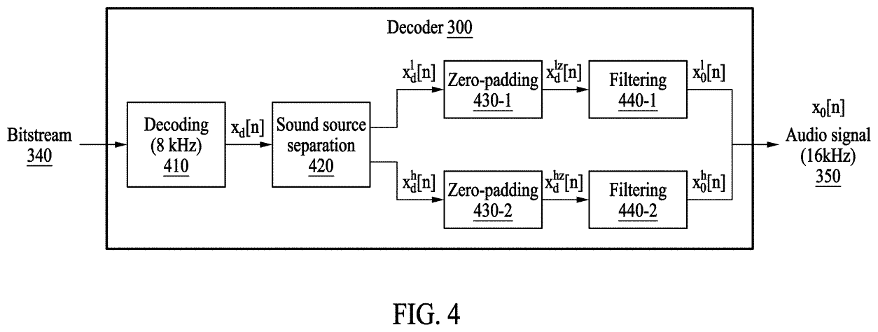

FIG. 4 is a diagram illustrating an operation of the decoder 300, according to various example embodiment.

In operation 410, the decoder 300 may calculate or determine a decoded signal by decoding the bitstream 340. For example, the decoded signal may represent a signal that restores the superimposed signal xₐ [n] of FIG. 2.

In operation 420, the decoder 300 may perform sound source separation on the decoded signal. For example, the sound source separator 330 may calculate or determine two-band signals x_{d}^{l[n] and x}_{d}^{h}[n] by performing sound source separation on the decoded signal. x_{d}^{l}[n] may represent a low-band signal and x_{d}^{h}[n] may represent a high-band signal.

In operation 430-1, the decoder 300 may zero-pad the low-band signal . In operation 440-1, the decoder 300 may determine xo [n] by filtering the zero-padded low-band signal x_{d}^{lz}[n].

For example, the LPF for filtering the zero-padded low-band signal x_{d}^{lz}[n] may be determined based on a frequency band of the zero-padded low-band signal x_{d}^{lz}[n]. The cutoff frequency of the LPF may be determined based on a frequency band of the zero-padded low-band signal x_{d}^{hz}[n].

In operation 430-2, the decoder 300 may zero-pad the high-band signal x_{d}^{h}[n]. In operation 440-2, the decoder 300 may determine x₀^{h}[n] by filtering the zero-padded high-and signal x_{d}^{hz}[n].

For example, the HPF for filtering the zero-padded high-band signal x_{d}^{hz}[n] may be determined based on a frequency band of the zero-padded high-band signal x_{d}^{hz}[n]. The cutoff frequency of the HPF may be determined based on a frequency band of the zero-padded high-band signal x_{d}^{hz}[n].

The decoder 300 may restore the audio signal 350 xₒ[n] by synthesizing the filtered low-band signal xₒ^{l}[n] and the filtered high-band signal xₒ^{h}[n]. For example, the restored audio signal 350 xₒ[n] may represent a signal that restores the audio signal 130 input to the encoder 100 of FIGS. 1 and 2.

For example, the decoder 300 may restore the audio signal 350 at a sampling rate that is greater than a sampling rate of a decoded signal. For example, in operation 410, the decoder 300 may decode a decoded signal at a sampling rate of 8 kHz. The decoder 300 may output the restored audio signal 350 xₒ[n] at a sampling rate of 16 kHz. The sampling rate of the decoded signal x_{d}[n] and the sampling rate of the restored audio signal 350 xₒ[n] are not limited to the examples illustrated in FIG. 4 and may be variously set.

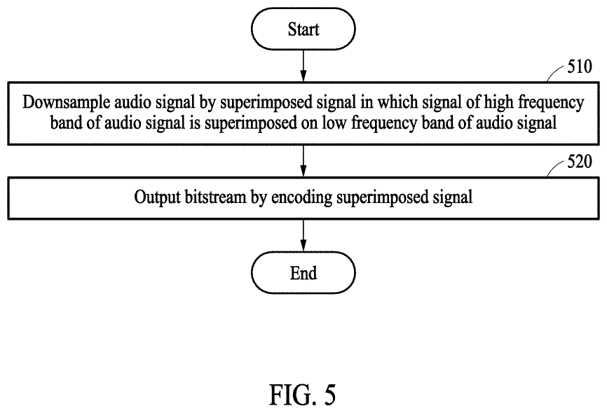

FIG. 5 is a flowchart illustrating an operation of an audio signal encoding method, according to various example embodiments.

Referring to FIG. 5, in operation 510, the encoder 100 may downsample an audio signal 130 with a superimposed signal in which a signal in a high frequency band of the audio signal 130 is superimposed on a low frequency band of the audio signal 130.

The superimposed signal may be a signal in which a signal in a high frequency band of the audio signal 130 is superimposed on a signal in a low frequency band as an aliasing signal.

In operation 520, the encoder 100 may output the bitstream 140 by encoding the superimposed signal.

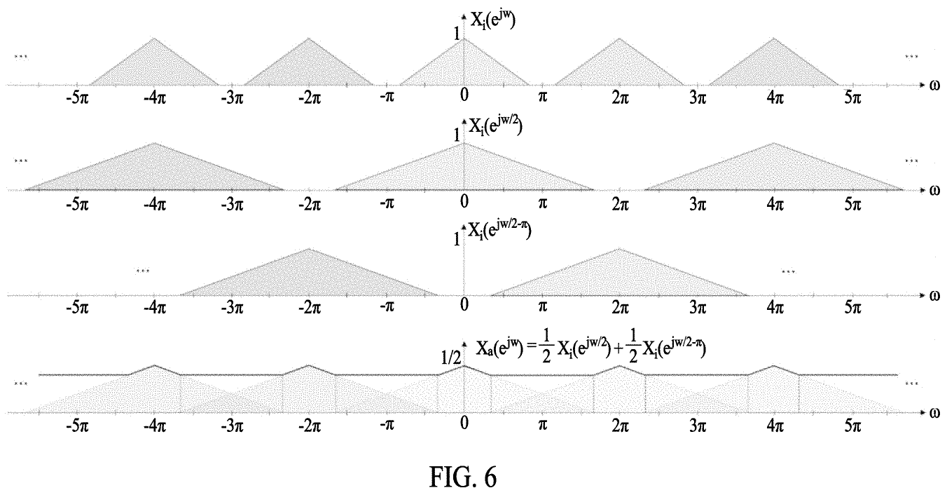

FIG. 6 is a diagram illustrating a superimposed signal according to various example embodiments.

Referring to FIG. 6, the encoder 100 may downsample the audio signal 130 with a superimposed signal in which a signal in a high frequency band of the audio signal 130 is superimposed on a low frequency band of the audio signal 130. For example, the encoder 100 may superimpose a component in a high frequency band of the audio signal 130 on a low frequency band as an aliasing signal.

The encoder 100 may generate a superimposed signal that samples the audio signal 130 as Equations 3 and 4. Equation 3 may represent a relationship between a superimposed signal xₐ[n] and the audio signal 130 xᵢ [n] in a time domain and Equation 4 may represent a relationship between a superimposed signal xₐ [n] and the audio signal 130 xᵢ [n] in a frequency domain.

$$\begin{matrix}{z}_{a} [ n ] = {x}_{i} [ 2 n ] & [ Equation 3 ] \\ {X}_{a} ( {e}^{j ω} ) = \frac{1}{2} {X}_{i} ( {e}^{j ω / 2} ) + \frac{1}{2} {X}_{i} ( {e}^{j ( ω / 2 - π )} ) & [ Equation 4 ]\end{matrix}$$

In Equations 1 and 2 shown above, xᵢ[n] may denote the audio signal 130, x ₐ[n] may denote a superimposed signal, Xᵢ(e^{jw}) and Xₐ (e^{jω}) may represent the discrete time

Fourier transform (DTFT) of xᵢ[n] and xₐ[n], respectively, and ω may denote each frequency.

A frequency domain ω ∈ (0, π)of (e^{jω}) may correspond to a low frequency domain with ω/2 ∈ (0, π/2) and may correspond to a high frequency domain with ω/2π∈ (−π, −π/2). Based on Equation 4 shown above, in a frequency domain ω∈ (0π) of Xₐ(e^{jω)ω/}2∈ (0, π/2), and thus, by Xᵢ (e^{jω/2} ), Xₐ(e^{jω}) may include a component of a low frequency band. Based on Equation 4 shown above, in a frequency domain ω∈ (0π) of Xₐ(e^{jω}), (ω/2 −π, −π/2), and thus, by Xᵢ(e^{j(ω/2-π)}), Xₐ(e^{jω}) may include a component of a high frequency band.

Accordingly, in all frequency bands of the superimposed signal xₐ [n], a low frequency component and a high frequency component of the audio signal 130 may exist together.

As illustrated in FIG. 6, Xₐ(e^{jω}) may include a component of a high frequency band and a component of a low frequency band of the audio signal 130. Xₐ(e^{jω}) may represent a superimposed signal in which the high frequency component is superimposed on a low frequency signal in the form of an aliasing signal.

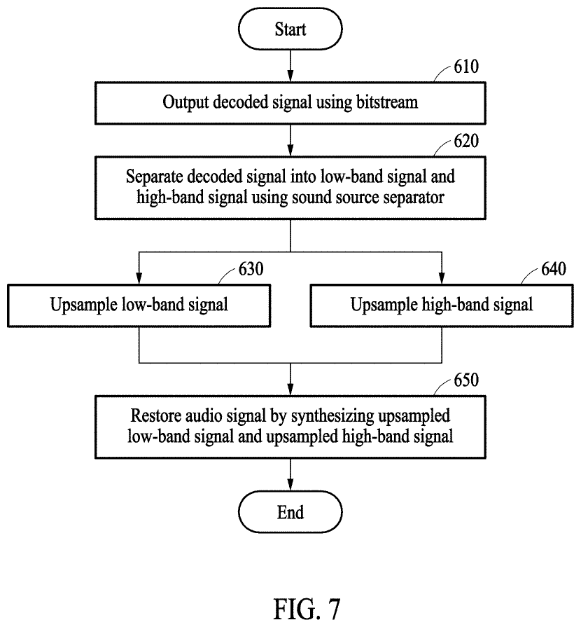

FIG. 7 is a flowchart of an operation of an audio signal decoding method according to various example embodiments.

Referring to FIG. 7, in operation 610, the decoder 300 may output a decoded signal by using the bitstream 340. The decoder 300 may output the decoded signal by decoding the bitstream 340 based on a set sampling rate.

In operation 620, the decoder 300 may separate a decoded signal into a low-band signal and a high-band signal by using the sound source separator 330.

The sound source separator 330 may include a neural network that is trained to separate a decoded signal into a low-band signal and a high-band signal. For example, the neural network may be trained to minimize a loss function determined based on SI-SNR.

In operation 630, the decoder 300 may upsample the low-band signal and in operation 640, the decoder 300 may upsample the high-band signal. The decoder 300 may zero-pad the low-band signal and may process the zero-padded low-band signal by using the LPF. The decoder 300 may zero-pad the high band signal and may process the zero-padded high-band signal by using the HPF.

In operation 650, the decoder 300 may restore the audio signal by synthesizing the upsampled low-band signal with the upsampled high-band signal. In operation 650, the sampling rate of the restored audio signal in operation 630 may be greater than the set sampling rate in operation 610.

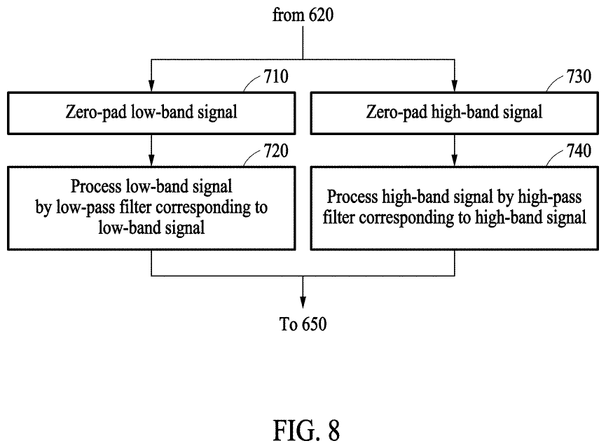

FIG. 8 is a diagram illustrating an upsampling operation according to various example embodiments.

In operation 710, the decoder 300 may zero-pad a low-band signal. For example, the decoder 300 may zero-pad a low-band signal based on the sampling rate set in operation 610 and the sampling rate of the audio signal 350 that is restored in operation 650 of FIG. 6.

In operation 720, the decoder 300 may filter the zero-padded low-band signal. For example, in operation 720, the decoder 300 may process the low-band signal by the LPF corresponding to the low-band signal. A cutoff frequency of the LPF may be determined based on a frequency band of a low-band signal. In operation 730, the decoder 300 may zero-pad the high-band signal. For example, the decoder 300 may zero-pad the high-band signal based on the set sampling rate in operation 610 and the sampling rate of the restored audio signal of operation 650 of FIG. 6.

In operation 740, the decoder 300 may filter the zero-padded high-band signal. For example, in operation 740, the decoder 300 may process the high-band signal by the HPF corresponding to the high-band signal. A cutoff frequency of the HPF may be determined based on a frequency band of a high-band signal.

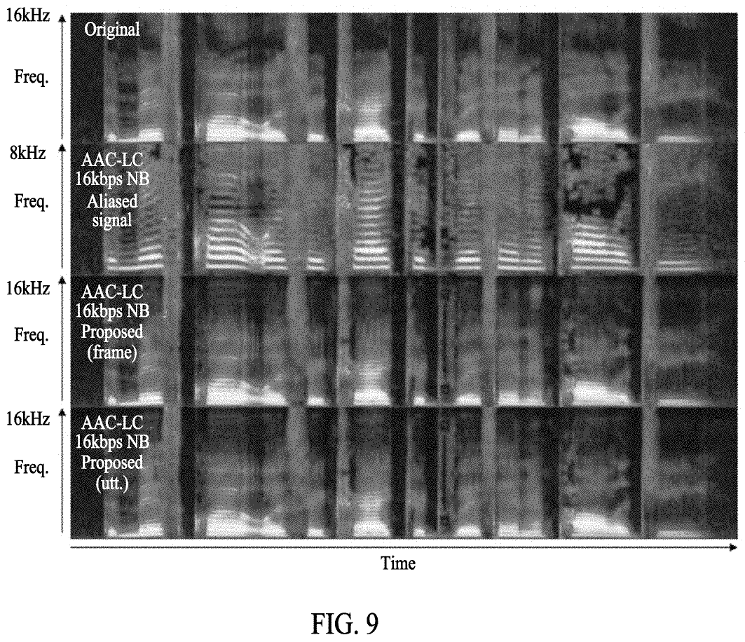

FIG. 9 is a diagram illustrating a spectrogram of an audio signal according to various example embodiments.

FIG. 9 illustrates spectrograms of each signal in a process of encoding and decoding an audio signal by using advanced audio coding-low complexity (AAC-LC).

FIG. 9 illustrates an audio signal (or an original signal) xᵢ [n] (e.g., Original of FIG. 9), a decoded signal x_{d}[n] (e.g., an AAC-LC 16kbps NB aliased signal of FIG. 9), a result of using a frame unit processing method (e.g., AAC-LC 16kbps Proposed (frame)), and a result of using an utterance unit processing method (e.g., AAC-LC 16kbps Proposed (utt.)). For example, the audio signal xᵢ [n] may represent an audio signal 130 input to the encoder 100 of FIGS. 1 and 2 and the decoded signal x_{d} [n] may represent the restored signal from a bitstream 340 in the decoder 300 of FIGS. 3 and 4.

The frame unit processing method may be a method in which sound source separation is performed on a decoded signal x_{d} [n] by dividing the decoded signal in the unit of 256 ms, and then restoring the entire signal by using an overlap-add method. The result of using the frame unit processing method may represent the audio signal xₒ[n] output by the decoder based on the frame unit processing method.

The utterance unit processing method may be a method that does not divide a signal and processes a signal by inputting all samples of the decoded signal x_{d}[n] to a sound source separator. The result of using the utterance unit processing method may represent the audio signal xₒ[n] output by the decoder based on the utterance unit processing method.

Since the frame unit processing method has a limit on context information of the input signal, the frame unit processing method may have degraded performance compared to the utterance unit processing method. However, the result by the frame unit processing method illustrated in FIG. 9 is similar to the result by the utterance unit processing method.

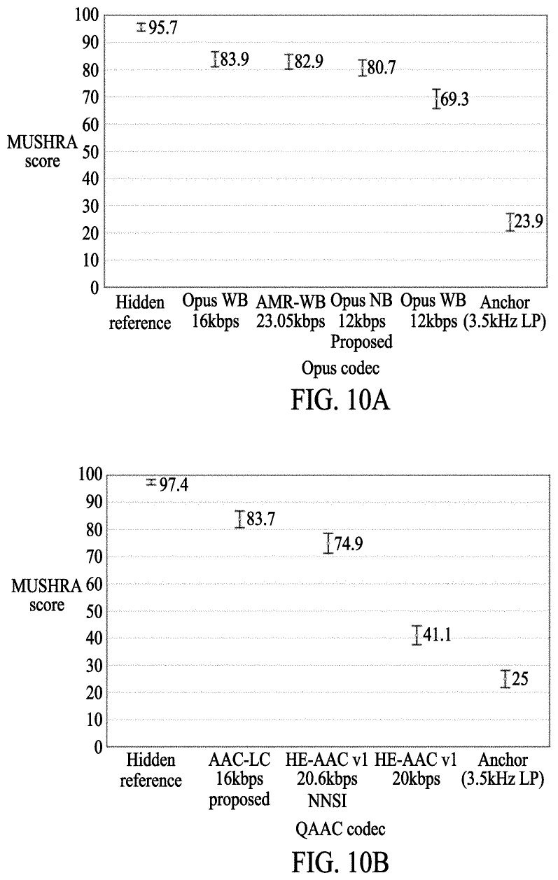

FIG. 10A and FIG. 10B are diagrams illustrating a result of listening evaluation of an audio signal according to various example embodiments.

FIG. 10A and FIG. 10B may represent a listening evaluation result conducted by using a voice signal to quantitatively evaluate quality improvement and/or refinement of an audio signal. For a listening evaluation method, a multiple stimuli with hidden reference and anchor

(MUSHRA) test may be used.

Herein, for the encoding method and/or the decoding method, AAC-LC 16 kbps of Opus NB 12 kbps, QAAC may be used as a legacy codec. According to various example embodiments, the legacy codec is not limited to the example illustrated in FIG. 10A and FIG. 10B and various codecs may be applicable. For example, the encoder may encode a superimposed signal and output a bitstream by using various legacy codecs. For example, the decoder may decode a bitstream and determine a decoded signal by using various legacy codecs.

For a comparison group for each result, Opus WB 12 kbps and 16 kbps and AMR-WB 23.05 kbps were used to evaluate Opus NB 12 kbps and a post-processing algorithm, which is HE-AAC vl 20 kbps, for HE-AAC vl 20.6 kbps was used to evaluate AAC-LC 16 kbps.

In FIG. 10A, the result of applying Opus NB 12 kbps shows about an 11.4 score difference compared to a result of using Opus WB 12 kbps, which is a wideband codec at the same bit rate, and is close to the result of using Opus WB 16 kbps and AMR-WB 23.05 kbps, which are wideband codecs at the higher bit rates.

In FIG. 10B, the result of applying AAC-LC 16 kbps shows score differences of 42.6 and 8.8 respectively compared to results of using HE-AAC v1 20 kbps and HE-AAC v1 20.6 kbps NNSI coded with the higher bit rates.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, for example, a computer program tangibly embodied in a machine readable storage device (a computer-readable medium) to process the operations of a data processing device, for example, a programmable processor, a computer, or a plurality of computers or to control the operations. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A method of encoding an audio signal, the method comprising:
outputting a decoded signal by using a bitstream that encodes an audio signal;
separating the decoded signal into a low-band signal and a high-band signal by using a sound source separator;
upsampling the low-band signal;
upsampling the high-band signal; and
restoring the audio signal by synthesizing the upsampled low-band signal with the upsampled high-band signal,
wherein the bitstream is generated by encoding a superimposed signal in which a signal in a high frequency band of the audio signal is superimposed on a low frequency band of the audio signal.

2. The method of claim 1, wherein the sound source separator comprises a neural network trained to separate the decoded signal into the low-band signal and the high-band signal.

3. The method of claim 2, wherein the neural network is trained to minimize a scale-invariant signal-to-noise ratio (SI-SNR) determined based on the audio signal and a restored audio signal.

4. The method of claim 1, wherein the upsampling of the low-band signal comprises:
zero-padding the low-band signal; and
processing the low-band signal by a low-pass filter corresponding to the low-band signal, and
wherein the upsampling of the high-band signal comprises:
zero-padding the high-band signal; and
processing the high-band signal by a high-pass filter corresponding to the high-band signal.

5. The method of claim 1, wherein the restoring of the audio signal comprises restoring the audio signal at a sampling rate that is higher than a sampling rate of the decoded signal.

6. A method of encoding an audio signal, the method comprising:
downsampling an audio signal by a superimposed signal in which a signal in a high frequency band of the audio signal is superimposed on a low frequency band of the audio signal; and
outputting a bitstream by encoding the superimposed signal.

7. The method of claim 6, wherein the downsampling of the audio signal comprises superimposing the signal of the high frequency band of the audio signal on the signal of the low frequency band as an aliasing signal.

8. A decoder comprising:
a processor,
wherein the processor is configured to:
output a decoded signal using a bitstream in which an audio signal is encoded,
separate the decoded signal into a low-band signal and a high-band signal by using a sound source separator,
upsample the low-band signal,
upsample the high-band signal, and
restore the audio signal by synthesizing the upsampled low-band signal with the upsampled high-band signal,
wherein the bitstream is generated by encoding a superimposed signal in which a signal in a high frequency band of the audio signal is superimposed on a low frequency band of the audio signal.

9. The decoder of claim 8, wherein the sound source separator comprises a neural network trained to separate the decoded signal into the low-band signal and the high-band signal.

10. The decoder of claim 9, wherein the neural network is trained to minimize a scale-invariant signal-to-noise ratio (SI-SNR) determined based on the audio signal and a restored audio signal.

11. The decoder of claim 8, wherein the processor is further configured to:
zero-pad the low-band signal,
process the low-band signal by a low-pass filter corresponding to the low-band signal,
zero-pad the high-band signal, and
process the high-band signal by a high-pass filter corresponding to the high-band signal.

12. The decoder of claim 8, wherein the processor is further configured to restore the audio signal at a sampling rate that is higher than a sampling rate of the decoded signal.
